(19) United States
(12) Patent Application Publication
(10) Pub. No.: US 2026/0291575 A1
(43) Pub. Date: Sep. 24, 2026

(54) METHOD AND APPARATUS FOR LOW COMPLEXITY DESIGN OF DISTRIBUTED HIGH-RANK MIMO TRANSMISSION IN MOBILE COMMUNICATIONS

(71) Applicant: MEDIATEK INC., Hsinchu City (TW)

(72) Inventor: Lung-Sheng TSAI, Hsinchu City (TW)

(73) Assignee: MEDIATEK INC., Hsinchu City (TW)

(21) Appl. No.: 19/473,293

(22) PCT Filed: Sep. 6, 2024
(86) PCT No.: PCT/CN2024/117599

§ 371 Date: Oct. 7, 2025

Related U.S. Application Data
(60) Provisional application No. 63/581,308, filed on Sep. 8, 2023.

(51) Int. Cl. H04B 7/06; H04L 5/00

(52) U.S. Cl. CPC H04B 7/0626; H04B 7/0639; H04L 5/0098

(57) ABSTRACT

Examples pertaining to a low complexity mode of distributed high-rank MIMO transmission in mobile communications are described. A mobile communication device communicating with a network node generates first precoding information implying a first precoding matrix and second precoding information implying a second precoding matrix according to a first channel response between the network node and a first group of antennas thereof, a second channel response between the network node and a second group of antennas thereof, and an assumption that a first signal precoded by the first precoding matrix and a second signal precoded by the second precoding matrix are transmitted from the network node on the same time-frequency resources. The first signal is decoded based on radio frequency (RF) signals received by the first group of antennas, and the second signal is decoded based on RF signals received by the second group of antennas

### CROSS REFERENCE TO RELATED PATENT APPLICATION(S)

The present disclosure is part of a non-provisional application claiming the priority benefit of U.S. Patent Application No. 63/581,308, filed 8 Sep. 2023, the content of which herein being incorporated by reference in its entirety.

### TECHNICAL FIELD

The present disclosure is generally related to mobile communications and, more particularly, to a low complexity design of distributed high-rank MIMO (Multiple Input Multiple Output) transmission in mobile communications.

### BACKGROUND

Unless otherwise indicated herein, approaches described in this section are not prior art to the claims listed below and are not admitted as prior art by inclusion in this section.

As 5G technology continues to evolve and expand, the New Radio (NR) network can support a wider range of applications for mobile communication devices, such as mobile phones and associated peripheral devices. The number of available antennas in MIMO transmission in the NR network can be higher than the Long-Term Evolution (LTE) network, thereby improving throughput. In general, the base station in the NR network, which is usually called a gNB (or gNodeB), has more available antennas than each mobile communication device since the mobile communication devices are required to meet the demands for compactness and portability and comply with the safety regulations such as the Specific Absorption Rate (SAR). Therefore, the degree of spatial multiplexing gain between the gNB and the mobile communication device is still limited by the number of available antennas on the mobile communication device.

In practice, users may simultaneously carry a mobile phone and a smartwatch (and/or other peripheral smart devices). Each of these mobile communication devices may have independent communication functions for connecting to the NR network and may camp on the same gNB. In this scenario, it is possible to integrate the antennas of one mobile communication device with those of another nearby device, effectively increasing the total number of available antennas for the mobile communication device. This increases the degree of spatial multiplexing gain between the gNB and the mobile communication device.

However, as the degree of spatial multiplexing gain is increased, the computational load on the mobile communication device also increases. This results in higher power consumption of the mobile communication device, which significantly reduces the overall usage time of the mobile communication device as the battery is quickly depleted.

Accordingly, the industry is striving to provide a communication mechanism that effectively reduces the computational load on the mobile communication device while increasing the degree of spatial multiplexing gain.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that provide a communication mechanism that effectively reduces the computational load on a mobile communication device (e.g., a user equipment (UE) of the NR network) while increasing the degree of spatial multiplexing gain between a network node (e.g., a gNB of the NR network) and the mobile communication device, thereby improving the overall signal transmission performance of the mobile network (e.g., the NR network).

In one aspect, a method for an apparatus communicating with a network node may involve the apparatus generating first precoding information implying a first precoding matrix and second precoding information implying a second precoding matrix, according to a first channel response between the network node and a first group of antennas of the apparatus, a second channel response between the network node and a second group of antennas of the apparatus, and an assumption that a first signal precoded by the first precoding matrix and a second signal precoded by the second precoding matrix are transmitted from the network node on the same time-frequency resources. The first signal is decoded based on first radio frequency (RF) signals received by the first group of antennas, and the second signal is decoded based on second RF signals received by the second group of antennas. The method may also involve the apparatus generating channel state information (CSI) including the first precoding information and the second precoding information. The method may further involve the apparatus transmitting the CSI to the network node.

In one aspect, a method may involve an apparatus receiving CSI from a UE, wherein the CSI comprises a first precoding information and a second precoding information. The method may also involve the apparatus generating a first precoded data signal and a second precoded data signal according to the CSI. The method may further involve the apparatus transmitting the first precoded data signal and the second precoded data signal to the UE on the same time-frequency resources.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a low complexity design of distributed high-rank MIMO (Multiple Input Multiple Output) transmission in mobile communications. According to the present disclosure, a number of possible solutions may be implemented separately or jointly. That is, although these possible solutions may be described below separately, two or more of these possible solutions may be implemented in one combination or another.

The communication mechanism of the present disclosure is applicable to a mobile communication network (e.g., an LTE network, a 5G/NR network, an IoT network or a 6G network). In this mobile communication network, a first UE and a second UE may camp on the same network node which provides a wide area coverage for long-range communication over a first frequency band. In addition, the first UE and the second UE may be located in close proximity to each other and may establish a short-range wireless connection with each other to perform short-range communication over a second frequency band (e.g., an unlicensed band).

The network node or the first UE itself may require the first UE to integrate the antennas of the first UE with the antennas of the second UE to effectively increase the total number of available antennas for the first UE, thereby increasing the degree of spatial multiplexing gain between the network node and the first UE and increasing the downlink throughput. Alternatively, the first UE may inherently have an adequate number of available antennas to achieve a higher degree of spatial multiplexing gain.

Considering the power consumption of the first UE, the network node or the first UE itself may require the first UE to operate in a low complexity mode while maintaining the same degree of spatial multiplexing gain. In this low complexity mode, the first UE may generate channel state information (CSI) including first precoding information and second precoding information (or further including first and second rank indicators (RIs) and first and second channel quality information (CQI)) based on the measurement results of the downlink reference signals received through two groups of antennas of the total available antennas, respectively. The first UE may transmit the CSI to the network node for precoding the downlink data signal. Therefore, with the precoded downlink data signal, the first UE may individually decode the downlink data signals received through the two groups of antennas, thereby reducing its computational load.

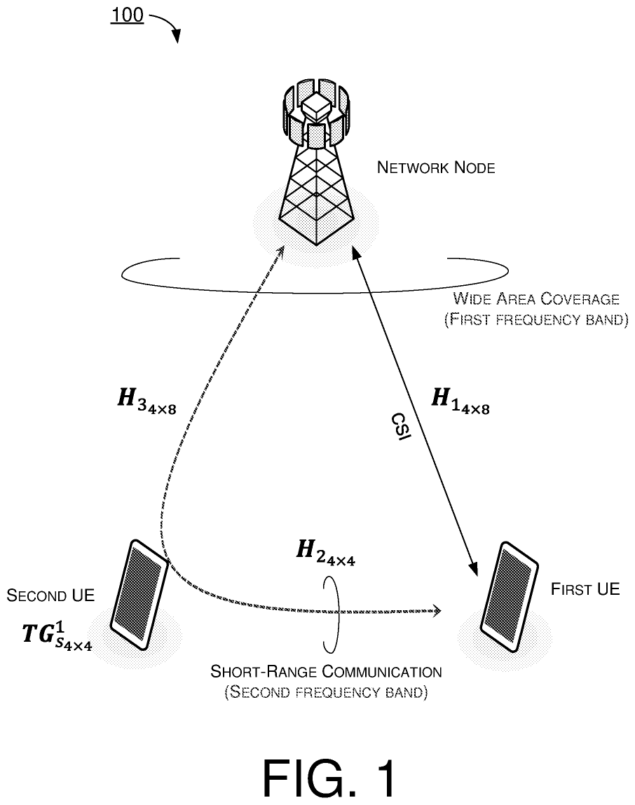

FIG. 1 illustrates an example scenario 100 under schemes in accordance with implementations of the present disclosure. Scenario 100 involves a mobile communication network (e.g., an NR network) including a network node (e.g., a gNB of the NR network), a first UE (e.g., a mobile phone or a peripheral smart device), and a second UE (e.g., a mobile phone or a peripheral smart device) proximal to the first UE. In the network framework of scenario 100, the first UE and the second UE may camp on the network node for long-range communication (e.g., mobile communication). The first UE and the second UE may connect directly to each other to perform short-range communication. For example, the first UE and the second UE may establish a Wi-Fi connection or any other short-range wireless connection.

In scenario 100, the first UE may act as a primary UE, and the second UE may act as a collaborative UE to assist the first UE in uplink transmission. The first UE may generate first precoding information implying (e.g., indicating) a first precoding matrix and second precoding information implying (e.g., indicating) a second precoding matrix according to a first channel response between the network node and a first group of antennas of the first UE, a second channel response between the network node and a second group of antennas of the first UE, and an assumption on which a first signal precoded by the first precoding matrix and a second signal precoded by the second precoding matrix are transmitted from the network node on the same time-frequency resources, the first signal is decoded based on first radio frequency (RF) signals received by the first group of antennas, and the second signal is decoded based on second RF signals received by the second group of antennas.

Specifically, the first precoding information may be configured to minimize a first effect of a first signal undergoing the second channel response on decoding a second signal received by the second group of antennas. The second precoding information may be configured to minimize a second effect of the second signal undergoing the first channel response on decoding the first signal received by the first group of antennas.

The following example shows how the first UE generates the first precoding information and the second precoding information. It is presumed that the first UE inherently has four antennas (i.e., the first group of antennas) for mobile communication, and the received signals (e.g., the first RF signal) of which is denoted as a matrix R₁_{_{4×1}}. The first UE inherently has four antennas (i.e., the second group of antennas) for short-range communication, and the received signals (e.g., the second RF signal) of which is denoted as a matrix R₂_{_{4×1}}. It is further presumed that the network node uses eight of its available antennas for communication with the first UE. The network node may transmit a plurality of reference signals through the eight antennas, respectively. Based on measurement of the reference signals, the first UE may perform a channel estimation and obtain a first channel response H₁_{_{4×8}} corresponding to the first group of antennas and a second channel response

$${H}_{{2}_{4 \times 4}} \cdot {TG}_{{s}_{4 \times 4}}^{1} \cdot {{H}_{3}}_{4 \times 8}$$

corresponding to the second group of antennas, where the H₁_{_{4×8}} is the channel gain matrix between the first UE and the network node, H₂_{_{4×4}} is the channel gain matrix between the first UE and the second UE,

$${TG}_{{s}_{4 \times 4}}^{1}$$

is the transform matrix representing the effect including carrier conversion, signal amplification and signal forwarding at the second UE, and the H₃_{_{4×8}} is the channel gain matrix between the second UE and the network node.

Under the above presumption, it is possible to design the desired first precoding information, denoted as a precoding matrix F₁, and the desired second precoding information, denoted as a precoding matrix F₂ from the following equations (1) and (2):

$${{R}_{1}}_{4 \times 1} = {{H}_{1}}_{4 \times 8} \{ {F}_{1} {F}_{2} ] \cdot {X}_{8 \times 1} + {n}_{1} \approx {{H}_{1}}_{4 \times 8} {F}_{1} [ \begin{matrix}{x}_{1} \\ {x}_{2} \\ {x}_{3} \\ {x}_{4}\end{matrix} ] + {n}_{1}^{′} \qquad ( 1 )$$

$${{R}_{2}}_{4 \times 1} = {{H}_{2}}_{4 \times 4} \cdot {TG}_{{s}_{4 \times 4}}^{1} \cdot {{H}_{3}}_{4 \times 8} \cdot [ {F}_{1} {F}_{2} ] \cdot {X}_{8 \times 1} + {n}_{2} \approx {H}_{{2}_{4 \times 4}} \cdot {TG}_{{s}_{4 \times 4}}^{1} \cdot {{H}_{3}}_{4 \times 8} {F}_{2} [ \begin{matrix}{x}_{5} \\ {x}_{6} \\ {x}_{7} \\ {x}_{8}\end{matrix} ] + {n}_{2}^{′} \qquad ( 2 )$$

where X_{8×1} is data signal for decoding, n₁ denotes the received noise by the first group of antennas, n₂ denotes the received noise by the second group of antennas,

$${n}_{1}^{′}$$

denoted the equivalent received noise containing the product value of

$${{H}_{1}}_{4 \times 8} \cdot {F}_{2} [ \begin{matrix}{x}_{5} \\ {x}_{6} \\ {x}_{7} \\ {x}_{8}\end{matrix} ] , and {n}_{2}^{′}$$

denoted the equivalent received noise containing the product value of

$${H}_{{2}_{4 \times 4}} \cdot {TG}_{{s}_{4 \times 4}}^{1} \cdot {{H}_{3}}_{4 \times 8} \cdot {F}_{1} [ \begin{matrix}{x}_{1} \\ {x}_{2} \\ {x}_{3} \\ {x}_{4}\end{matrix} ] .$$

In equations (1), the product value of

$${{H}_{1}}_{4 \times 8} \cdot {F}_{2} [ \begin{matrix}{x}_{5} \\ {x}_{6} \\ {x}_{7} \\ {x}_{8}\end{matrix} ]$$

is treated as interference and is added to n₁, resulting in

$${n}_{1}^{′} .$$

in equations (2), the product value of

$${H}_{{2}_{4 \times 4}} \cdot {TG}_{{s}_{4 \times 4}}^{1} \cdot {{H}_{3}}_{4 \times 8} \cdot {F}_{2} [ \begin{matrix}{x}_{1} \\ {x}_{2} \\ {x}_{3} \\ {x}_{4}\end{matrix} ]$$

is treated as interference and is added with n₂, resulting in

$${n}_{2}^{′} .$$

In view of the above, in order to minimize the product value of

$${{H}_{1}}_{4 \times 8} \cdot {F}_{2} [ \begin{matrix}{x}_{5} \\ {x}_{6} \\ {x}_{7} \\ {x}_{8}\end{matrix} ]$$

and the product value of

$${H}_{{2}_{4 \times 4}} \cdot {TG}_{{s}_{4 \times 4}}^{1} \cdot {{H}_{3}}_{4 \times 8} \cdot {F}_{1} [ \begin{matrix}{x}_{1} \\ {x}_{2} \\ {x}_{3} \\ {x}_{4}\end{matrix} ] ,$$

the precoding matrix F₁ may be formed by the basis of the null space of

$${H}_{{2}_{4 \times 4}} \cdot {TG}_{{s}_{4 \times 4}}^{1} \cdot {{H}_{3}}_{4 \times 8} ,$$

and the precoding matrix F₂ may be formed by the basis of the null space of H₁_{_{4×8}}.

As a result, the first UE may generate the first precoding information configured to minimize the first effect

$$( i . e . , the product value of {H}_{{2}_{4 \times 4}} \cdot {TG}_{{s}_{4 \times 4}}^{1} \cdot {{H}_{3}}_{4 \times 8} \cdot {F}_{1} [ \begin{matrix}{x}_{1} \\ {x}_{2} \\ {x}_{3} \\ {x}_{4}\end{matrix} ] )$$

of the first signal (i.e., x₁, x₂, x₃, x₄) undergoing the second channel response

$$( i . e . , {H}_{{2}_{4 \times 4}} \cdot {TG}_{{S}_{4 \times 4}}^{1} \cdot {H}_{{3}_{4 \times 8}} )$$

on decoding the second signal (i.e., x₅, x₆, x₇, x₈) received by the second group of antennas. Furthermore, the first UE may generate the second precoding information (i.e., F₂) configured to minimize a second effect

$$( i . e . , {H}_{{1}_{4 \times 8}} \cdot {F}_{2} [ \begin{matrix}{x}_{5} \\ {x}_{6} \\ {x}_{7} \\ {x}_{8}\end{matrix} ] )$$

of the second signal (i.e., x₅, x₆, x₇, x₈) undergoing the first channel response (i.e., H₁_{_{4×8}}) on decoding the first signal (i.e., x₁, x₂, x₃, x₄) received by the first group of antennas.

Next, the first UE may generate CSI including the first precoding information and the second precoding information. Consequently, the first UE may transmit the CSI to the network node.

The network node may receive the CSI including the first precoding information and the second precoding information from the first UE. Next, the network node may generate a precoded data signal according to the CSI. The precoded data signal is composed of a first precoded data signal and a second precoded data signal that may be precoded according to the first precoding information and the second precoding information, respectively. After generating the precoded data signal, the network may transmit the precoded data signal to the first UE. As a result, with the precoded data signal, the first UE may individually decode the first four layers of the precoded data signal received by the first group of antennas (i.e., R₁_{_{4×1}}) and decode the other four layers of the precoded data signal received by the second group of antennas (i.e., R₂_{_{4×1}}).

In some embodiments, as shown in scenario 100, the first channel response is associated with the first frequency band for long-range communication, and the second channel response is associated with the first frequency band for long-range communication and the second frequency band for short-range communication. The first group of antennas may receive the first RF signals in the first frequency band and the second group of antennas may receive the second RF signals in the second frequency band different from the first frequency band. The first RF signals received in the first frequency band and the second RF signals received in the second frequency band carrying the same baseband signals (e.g., X_{8×1} or reference signals for channel estimation) transmitted by the network node.

In some cases, the first channel response (e.g., H₁_{_{4×8}}) may indicate a first channel characteristic between a plurality of antennas of the network node and the first group of antennas of the first UE on the first frequency band, and the second channel response

$$( e . g . , {H}_{{2}_{4 \times 4}} \cdot {TG}_{{S}_{4 \times 4}}^{1} \cdot {H}_{{3}_{4 \times 8}} )$$

may indicate a combined channel characteristic of a second channel characteristic between the antennas of the network node and a plurality of antennas of the second UE proximal to the first UE on the first frequency band and a third channel characteristic between the antennas of the second UE and the second group of antennas of the first UE on second frequency band.

In some embodiments, the first group of antennas and the second group of antennas of the first UE may share at least one antenna. Specifically, in Scenario 100, the first UE may inherently have four antennas that are capable of simultaneously supporting both the mobile communication between the first UE and the network node over the first frequency band and the short-range communication between the first UE and the second UE over the second frequency band.

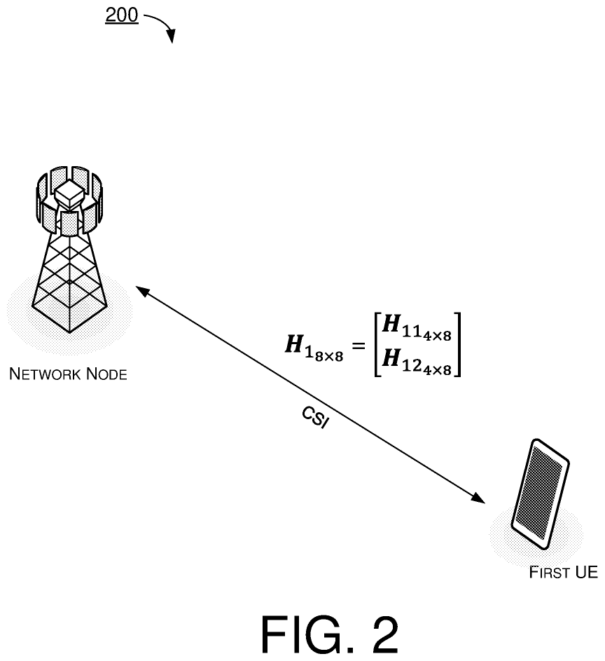

In other embodiments, FIG. 2 illustrates an example scenario 200 under schemes in accordance with implementations of the present disclosure. In scenario 200, the first UE may inherently have enough antennas for mobile communication without the need to integrate the antennas of the second UE.

The following example shows how the first UE generates the first precoding information and the second precoding information. It is presumed that the first UE inherently has eight antennas for mobile communication. The received signals (e.g., the first RF signal) of four antennas (i.e., the first group of antennas) of the eight antennas is denoted as a matrix R₁_{_{4×1}}. The received signals (e.g., the second RF signal) of the other four antennas (i.e., the second group of antennas) of the eight antennas is denoted as a matrix R₂_{_{4×1}}. It is also presumed that the network node uses eight of its available antennas for communication with the first UE. The network node may transmit a plurality of reference signals through the eight antennas, respectively. Based on the reference signals, the first UE may perform a channel estimation and obtain a first channel response H₁₁_{_{4×8}} corresponding to the first group of antennas and R₁_{_{4×1}} and a second channel response H₁₂_{_{4×8}} corresponding to the second group of antennas and R₂_{_{4×1}}, where the H₁₁_{_{4×8}} is the channel gain matrix between the first group of antennas (i.e., the four Rx-ports) of the first UE and the eight antennas (i.e., the eight Tx-ports) of the network node, and H₁₂_{_{4×8}} is the channel gain matrix between the second group of antennas (i.e., the other four Rx-ports) of the first UE and the eight antennas (i.e., the eight Tx-ports) of the network node.

Under the above presumption, it is possible to design the desired first precoding information, denoted as a precoding matrix F₁, and the desired first precoding information, denoted as a precoding matrix F₂ from the following equations (3) and (4):

$${R}_{{1}_{4 \times 1}} = {H}_{{11}_{4 \times 8}} [ \begin{matrix}{F}_{1} & {F}_{2}\end{matrix} ] \cdot {X}_{8 \times 1} + {n}_{1} \approx {H}_{{11}_{4 \times 8}} {F}_{1} [ \begin{matrix}{x}_{1} \\ {x}_{2} \\ {x}_{3} \\ {x}_{4}\end{matrix} ] + {n}_{1}^{′} \qquad ( 3 )$$

$${R}_{{2}_{4 \times 1}} = {H}_{{12}_{4 \times 8}} \cdot [ \begin{matrix}{F}_{1} & {F}_{2}\end{matrix} ] \cdot {X}_{8 \times 1} + {n}_{2} \approx {H}_{{12}_{4 \times 8}} {F}_{2} [ \begin{matrix}{x}_{5} \\ {x}_{6} \\ {x}_{7} \\ {x}_{8}\end{matrix} ] + {n}_{2}^{′} \qquad ( 4 )$$

where X_{8×1} is a matrix representing data signals to be decoded, n₁ denotes received noise by the first group of antennas, n₂ denotes received noise by the second group of antennas,

$${n}_{1}^{′}$$

denoted the equivalent received noise containing the product value of

$${H}_{{11}_{4 \times 8}} \cdot {F}_{2} [ \begin{matrix}{x}_{5} \\ {x}_{6} \\ {x}_{7} \\ {x}_{8}\end{matrix} ] , and {n}_{2}^{′}$$

denoted the equivalent received noise containing the product value of

$${H}_{{12}_{4 \times 8}} \cdot {F}_{1} [ \begin{matrix}{x}_{1} \\ {x}_{2} \\ {x}_{3} \\ {x}_{4}\end{matrix} ] \cdot {H}_{{1}_{8 \times 8}} = [ \begin{matrix}{H}_{{11}_{4 \times 8}} \\ {H}_{{12}_{4 \times 8}}\end{matrix} ]$$

denotes the channel gain matrix between the eight Tx-ports of the network node and the eight Rx-ports of the first UE. In equations (3), the product value of

$${H}_{{11}_{4 \times 8}} \cdot {F}_{2} [ \begin{matrix}{x}_{5} \\ {x}_{6} \\ {x}_{7} \\ {x}_{8}\end{matrix} ]$$

is treated as interference and is added to n₁, resulting in

$${n}_{1}^{′} .$$

In equation (4), the product value of

$${H}_{{12}_{4 \times 8}} \cdot {F}_{1} [ \begin{matrix}{x}_{1} \\ {x}_{2} \\ {x}_{3} \\ {x}_{4}\end{matrix} ]$$

is treated as interference and is added to n₂, resulting in

$${n}_{2}^{′} .$$

Similarly, in view of the above, in order to minimize the product value of

$${H}_{{11}_{4 \times 8}} \cdot {F}_{2} [ \begin{matrix}{x}_{5} \\ {x}_{6} \\ {x}_{7} \\ {x}_{8}\end{matrix} ]$$

and the product value of

$${H}_{{12}_{4 \times 8}} \cdot {F}_{1} [ \begin{matrix}{x}_{1} \\ {x}_{2} \\ {x}_{3} \\ {x}_{4}\end{matrix} ] ,$$

the precoding matrix F₁ may be formed by the basis of the null space of H₁₂_{_{4×8}}, and the precoding matrix F₂ may be formed by the basis of the null space of H₁₁_{_{4×8}}.

As a result, the first UE may generate the first precoding information configured to minimize the first effect (i.e., the product value of

$${H}_{{12}_{4 \times 8}} \cdot {F}_{1} [ \begin{matrix}{x}_{1} \\ {x}_{2} \\ {x}_{3} \\ {x}_{4}\end{matrix} ] )$$

of the first signal (i.e., x₁, x₂, x₃, x₄) undergoing the second channel response (i.e., H₁₂_{_{4×8}}) on decoding the second signal (i.e., x₅, x₆, x₇, x₈) received by the second group of antennas, and the second precoding information (i.e., F₂) configured to minimize a second effect

$$( i . e . , {H}_{{11}_{4 \times 8}} \cdot {F}_{2} [ \begin{matrix}{x}_{5} \\ {x}_{6} \\ {x}_{7} \\ {x}_{8}\end{matrix} ] )$$

of the second signal (i.e., x₅, x₆, x₇, x₈) undergoing the first channel response (i.e., H₁₁_{_{4×8}}) on decoding the first signal (i.e., x₁, x₂, x₃, x₄) received by the first group of antennas.

Similarly, the first UE may generate CSI including the first precoding information and the second precoding information. Then, the first UE may transmit the CSI to the network node. After receiving the CSI from the first UE, the network node may generate a precoded data signal according to the CSI. Next, the network node may transmit the precoded data signal to the first UE. As a result, with the precoded data signal, the first UE may individually decode the first four layers of the precoded data signal received by the first group of antennas (i.e., R₁_{_{4×1}}) and decode the other four layers of the precoded data signal received by the second group of antennas (i.e., R₂_{_{4×1}}).

In the above examples, the first group of antennas is presumed to have four antennas, and the second group of the antennas is presumed to have four antennas. However, in practice, the number of the first group of antennas and the number of the second group of antennas are limitative. The first UE may indicate the number of the first group of antennas and the number of the second group of antennas by the first precoding information and the second precoding information. Specifically, the numbers of the column vectors in the F₁ and F₂ are no greater than the number of the first group of antennas and the number of the second group of antennas, respectively.

In some embodiments in scenario 100 or 200, the CSI may further include at least one of a first rank indicator (RI) and first channel quality information (CQI), and at least one of a second RI and second CQI. The first RI may be equal to a number of columns of the first precoding matrix (e.g., F₁) and the first CQI may indicate channel quality for decoding the first signal (e.g., the channel quality corresponding to equation (3)). Similarly, the second RI may be equal to a number of columns of the second precoding matrix (e.g., F₂) and the second CQI may indicate channel quality for decoding the second signal (e.g., the channel quality corresponding to equation (4)).

In some embodiments in scenario 100 or 200, with respect to generating the CSI, the first UE may generate a first CSI report message including at least one of the first precoding information, the first RI and the first CQI, and a second CSI report message including at least one of the second precoding information, the second RI and the second CQI. The first UE may transmit the first CSI report message and the second CSI report message separately to the network node. The network node may receive the first CSI report message and the second CSI report message separately.

In some embodiments in scenario 100 or 200, with respect to generating the CSI, the first UE may generate a CSI report message including the first precoding information, the second precoding information, at least one of the first RI and the first CQI, and at least one of the second RI and the second CQI. The first UE may transmit the CSI report message to the network node. That is to say, the first UE may jointly report the first precoding information, the second precoding information, at least one of the first RI and the first CQI, and at least one of the second RI and the second CQI using a single CSI report message. The network node may receive the single CSI report message to obtain the first precoding information, the second precoding information, at least one of the first RI and the first CQI, and at least one of the second RI and the second CQI.

In some embodiments in scenario 200, the first channel response (e.g., H₁₁_{_{4×8}}) and the second channel response (e.g., H₁₂_{_{4×8}}) may be associated with the same frequency band (e.g., the first frequency band for long-range communication). The first group of antennas and the second group of antennas may receive the first RF signals and the second RF signals in the same frequency band, respectively. The first RF signals and the second RF signals may carry the same baseband signals transmitted by the network node.

In some cases, the first channel response (e.g., H₁₁_{_{4×8}}) may indicate a first channel characteristic between a plurality of antennas of the network node and the first group of antennas of the first UE, and the second channel response (e.g., H₁₂_{_{4×8}}) may indicate a second channel characteristic between the antennas of the network node and the second group of antennas of the first UE.

In some embodiments in scenario 100 or 200, the first UE may receive a data signal (e.g., the precoded data signal) from the network node via the first group of antennas and the second group of antennas, as described above. The data signal may be precoded according to the first precoding information (e.g., F₁) and the second precoding information (e.g., F₂). Therefore, the first UE may extract a part of data from the data signal received by the first group of antennas (e.g., by decoding the first four layers of the precoded data signal, x₁, x₂, x₃, x₄) and may extract a remaining part of the data from the data signal received by the second group of antennas (e.g., by decoding the other four layers of the precoded data signal, x₅, x₆, x₇, x₈).

In some embodiments, the network node may transmit a plurality of reference signals. The first UE may receive, via the first group of antennas and the second group of antennas, the reference signals. Next, the first UE may estimate the first channel response between the network node and the first group of antennas and the second channel response between the network node and the second group of antennas according to the referenced signals.

In some embodiments, the network node may transmit a mode switching message to the first UE to instruct the first UE to switch to a mode (e.g., a low complexity mode) in which the first signal is decoded independently according to the first RF signals received by the first group of antennas and the second signal is decoded independently according to the second RF signals received by the second group of antennas according to the mode switching message. Consequently, the first UE may receive the mode switching message from the network node. Then, the first UE may switch to the mode according to the mode switching message. After switching to the mode, the first UE will perform the operations described in the above embodiments corresponding to either Scenario 100 or 200.

### Illustrative Implementations

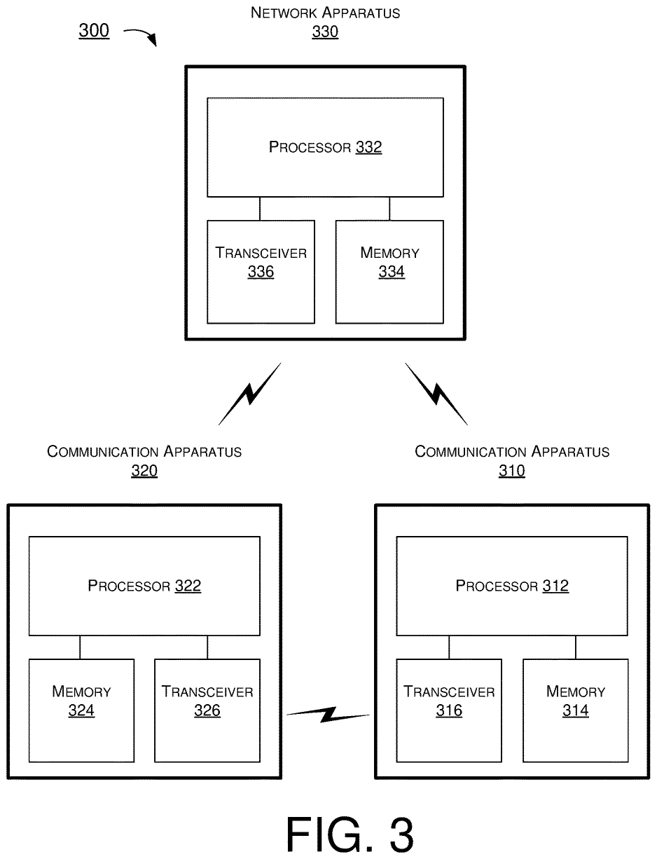

FIG. 3 illustrates an example communication system 300 having an example communication apparatus 310, an example communication apparatus 320, and an example network apparatus 330 in accordance with an implementation of the present disclosure. Each of communication apparatus 310/320 and network apparatus 330 may perform various functions to implement schemes, techniques, processes and methods described herein pertaining to device collaboration in an unlicensed band or a licensed band in mobile communications, including scenarios/schemes described above as well as process 400 and process 500 described below.

Communication apparatus 310/320 may be a part of an electronic apparatus, which may be a UE such as a portable or mobile apparatus, a wearable apparatus, a mobile communication apparatus or a computing apparatus. For instance, communication apparatus 310/320 may be implemented in a smartphone, a smartwatch, a personal digital assistant, a digital camera, or a computing equipment such as a tablet computer, a laptop computer or a notebook computer. Communication apparatus 310/320 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310/320 may be implemented in a smart thermostat, a smart fridge, a smart door lock, a wireless speaker or a home control center. Alternatively, communication apparatus 310/320 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310/320 may include at least some of those components shown in FIG. 3 such as a processor 312/322, for example. Communication apparatus 310/320 may further include one or more other components not pertinent to the proposed scheme of the present disclosure (e.g., internal power supply, display device and/or user interface device), and, thus, such component(s) of communication apparatus 310/320 are neither shown in FIG. 3 nor described below in the interest of simplicity and brevity.

Network apparatus 330 may be a part of a network device, which may be a network node such as a satellite, a base station, a small cell, a router or a gateway. For instance, network apparatus 330 may be implemented in an eNodeB in an LTE network, in a gNB in a 5G/NR, IoT, NB-IoT or IIoT network or in a satellite or base station in a 6G network. Alternatively, network apparatus 330 may be implemented in the form of one or more IC chips such as, for example and without limitation, one or more single-core processors, one or more multi-core processors, or one or more RISC or CISC processors. Network apparatus 330 may include at least some of those components shown in FIG. 3 such as a processor 332, for example. Network apparatus 330 may further include one or more other components not pertinent to the proposed scheme of the present disclosure (e.g., internal power supply, display device and/or user interface device), and, thus, such component(s) of network apparatus 330 are neither shown in FIG. 3 nor described below in the interest of simplicity and brevity.

In one aspect, each of processor 312, processor 322 and processor 332 may be implemented in the form of one or more single-core processors, one or more multi-core processors, or one or more CISC processors. That is, even though a singular term “a processor” is used herein to refer to processor 312, processor 322 and processor 332, each of processor 312, processor 322 and processor 332 may include multiple processors in some implementations and a single processor in other implementations in accordance with the present disclosure. In another aspect, each of processor 312, processor 322 and processor 332 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312, processor 322 and processor 332 is a special-purpose machine specifically designed, arranged and configured to perform specific tasks including the low complexity design of distributed high-rank MIMO transmission in a device (e.g., as represented by communication apparatus 310 and communication apparatus 320) and a network (e.g., as represented by network apparatus 330) in accordance with various implementations of the present disclosure.

In some implementations, communication apparatus 310 may also include a transceiver 316 coupled to processor 312 and capable of wirelessly transmitting and receiving data. In other words, processor 312 may transceive the data such as configuration, message, signal, information, indicator, etc. via transceiver 316. In some implementations, communication apparatus 310 may further include a memory 314 coupled to processor 312 and capable of being accessed by processor 312 and storing data therein. In some implementations, communication apparatus 320 may also include a transceiver 326 coupled to processor 322 and capable of wirelessly transmitting and receiving data. In other words, processor 322 may transceive the data such as configuration, message, signal, information, indicator, etc. via transceiver 326. In some implementations, communication apparatus 320 may further include a memory 324 coupled to processor 322 and capable of being accessed by processor 322 and storing data therein. In some implementations, network apparatus 330 may also include a transceiver 336 coupled to processor 332 and capable of wirelessly transmitting and receiving data. In other words, processor 332 may transceive the data such as configuration, message, signal, information, indicator, etc. via transceiver 336. In some implementations, network apparatus 330 may further include a memory 334 coupled to processor 332 and capable of being accessed by processor 232 and storing data therein. Accordingly, communication apparatus 310, communication apparatus 320 and network apparatus 330 may wirelessly communicate with each other via transceiver 316, transceiver 326 and transceiver 336, respectively.

To aid better understanding, the following description of the operations, functionalities and capabilities of each of communication apparatus 310/320 and network apparatus 330 is provided in the context of a mobile communication environment in which communication apparatus 310/320 is implemented in or as a communication apparatus or a UE (e.g., the first UE) and network apparatus 330 is implemented in or as a network node of a communication network.

In some implementations, each of memory 314, 324 and memory 334 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 314, 324 and memory 334 may include a type of read-only memory (ROM) such as mask ROM, programmable ROM (PROM), erasable programmable ROM (EPROM) and/or electrically erasable programmable ROM (EEPROM). Alternatively, or additionally, each of memory 314, 324 and memory 334 may include a type of non-volatile random-access memory (NVRAM) such as flash memory, solid-state memory, ferroelectric RAM (FeRAM), magnetoresistive RAM (MRAM) and/or phase-change memory.

### Illustrative Processes

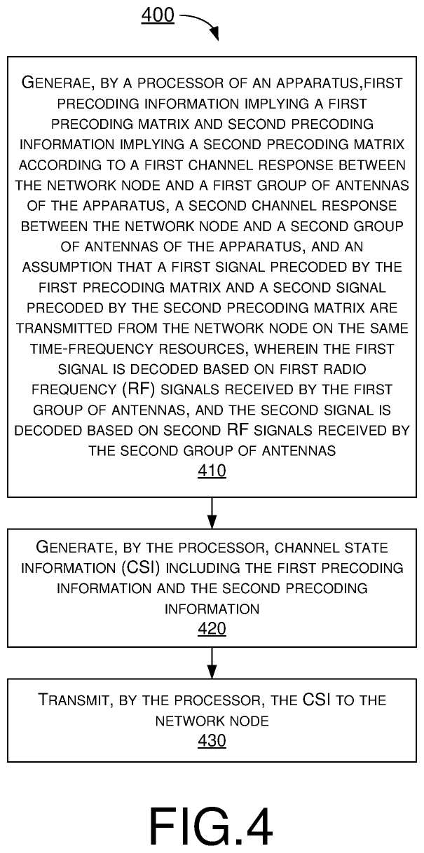

FIG. 4 illustrates an example process 400 in accordance with an implementation of the present disclosure. Process 400 may be an example implementation of above scenarios/schemes, whether partially or completely, with respect to device collaboration in an unlicensed band or a licensed band in mobile communications of the present disclosure. Process 400 may represent an aspect of implementation of features of communication apparatus 310. Process 400 may include one or more operations, actions, or functions as illustrated by one or more of blocks 410 to 440. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable communication device or machine type devices. Solely for illustrative purposes and without limitation, process 400 is described below in the context of communication apparatus 310. Process 400 may begin at block 410.

At block 410, process 400 may involve processor 312 of communication apparatus 310 generating first precoding information implying a first precoding matrix and second precoding information implying a second precoding matrix according to a first channel response between the network node and a first group of antennas of the apparatus, a second channel response between the network node and a second group of antennas of the apparatus, and an assumption that a first signal precoded by the first precoding matrix and a second signal precoded by the second precoding matrix are transmitted from the network node on the same time-frequency resources. The first signal is decoded based on first radio frequency (RF) signals received by the first group of antennas, and the second signal is decoded based on second RF signals received by the second group of antennas. Process 400 may proceed from block 410 to block 420.

At block 420, process 400 may involve processor 312 generating channel state information (CSI) including the first precoding information and the second precoding information. Process 400 may proceed from block 420 to block 430.

At block 430, process 400 may involve processor 312 transmitting the CSI to the network node.

In some implementations, the CSI may further include at least one of a first rank indicator (RI) equal to a number of columns of the first precoding matrix and first channel quality information (CQI) indicating channel quality for decoding the first signal, and at least one of a second RI equal to a number of columns of the second precoding matrix and second CQI indicating channel quality for decoding the second signal.

In some implementations, for transmitting of the CSI to the network node, process 400 may further involve processor 312 generating a first CSI report message including at least one of the first precoding information, the first RI and the first CQI, and a second CSI report message including at least one of the second precoding information, the second RI and the second CQI, and transmitting the first CSI report message and the second CSI report message separately to the network node.

In some implementations, for transmitting of the CSI to the network node, process 400 may further involve processor 312 generating a CSI report message including the first precoding information, the second precoding information, at least one of the first RI and the first CQI, and at least one of the second RI and the second CQI, and transmitting the CSI report message to the network node.

In some implementations, the first group of antennas may receive the first RF signals in a first frequency band, the second group of antennas may receive the second RF signals in a second frequency band different from the first frequency band, and the first RF signals received in the first frequency band and the second RF signals received in the second frequency band may carry the same baseband signals transmitted by the network node.

In some implementations, the first group of antennas and the second group of antennas may share at least one antenna.

In some implementations, the first group of antennas and the second group of antennas may receive the first RF signals and the second RF signals in the same frequency band, respectively, and the first RF signals and the second RF signals may carry the same baseband signals transmitted by the network node.

In some implementations, process 400 may further involve processor 312 receiving a data signal from the network node via the first group of antennas and the second group of antennas, extracting a part of data from the data signal received by the first group of antennas, and extracting a remaining part of the data from the data signal received by the second group of antennas.

In some implementations, process 400 may further involve processor 312 receiving, via the first group of antennas and the second group of antennas, a plurality of reference signals transmitted by the network node, and estimating the first channel response between the network node and the first group of antennas and the second channel response between the network node and the second group of antennas according to the referenced signals.

In some implementations, process 400 may further involve processor 312 receiving a mode switching message from the network node, and switching to a mode in which the first signal is decoded independently according to the first RF signals received by the first group of antennas and the second signal is decoded independently according to the second RF signals received by the second group of antennas according to the mode switching message.

In some implementations, the first precoding information may indicate a number of the first group of antennas, and the second precoding information may indicate a number of the second group of antennas.

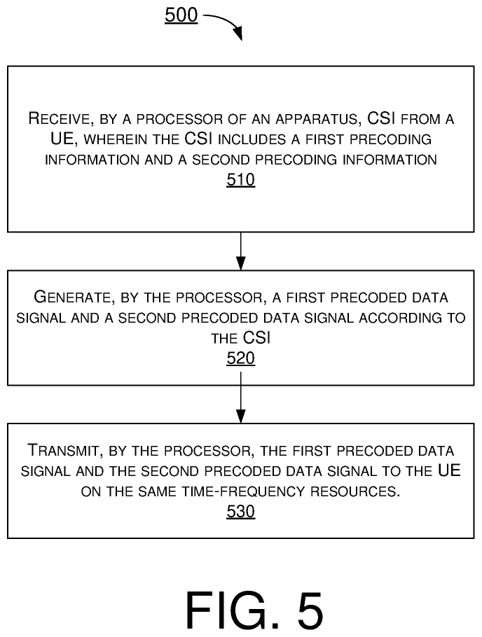

FIG. 5 illustrates an example process 500 in accordance with an implementation of the present disclosure. Process 500 may be an example implementation of above scenarios/schemes, whether partially or completely, with respect to device collaboration in an unlicensed band or a licensed band in mobile communications of the present disclosure. Process 500 may represent an aspect of implementation of features of network apparatus 330. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 330 or any suitable network device or machine type devices. Solely for illustrative purposes and without limitation, process 500 is described below in the context of network apparatus 330.

At block 510, process 500 may involve processor 332 of network apparatus 330 receiving CSI from a UE. The CSI may include a first precoding information and a second precoding information. Process 500 may proceed from block 510 to block 520.

At block 520, process 500 may involve processor 332 generating a first precoded data signal and a second precoded data signal according to the CSI. Process 500 may proceed from block 520 to block 530.

At block 530, process 500 may involve processor 332 transmitting the first precoded data signal and the second precoded data signal to the UE on the same time-frequency resources.

In some implementations, the CSI may further include at least one of a first RI and a first CQI, and at least one of a second RI and a second CQI.

In some implementations, for receiving of the CSI from the UE, process 500 may further involve processor 332 receiving a first CSI report message including at least one of the first precoding information, the first RI and the first CQI, and receiving a second CSI report message including at least one of the second precoding information, the second RI and the second CQI.

In some implementations, for receiving of the CSI, from the UE, process 500 may further involve processor 332 receiving a CSI report message including the first precoding information, the second precoding information, at least one of the first RI and the first CQI, and at least one of the second RI and the second CQI.

In some implementations, the first RI, the first CQI and the first precoding information may correspond to a first group of antennas of the UE, and the second RI, the second CQI and the second precoding information may correspond to a second group of antennas of the UE.

In some implementations, process 500 may further involve processor 332 transmitting a plurality of reference signals to the UE for generating the CSI based on measurement of the reference signals.

In some implementations, process 500 may further involve processor 332 transmitting a mode switching message to the UE. The mode switching message may indicate the UE to switch to a mode in which the first precoded data signal is decoded independently according to first RF signals received by the first group of antennas, the second precoded data signal is decoded independently according to second RF signals received by the second group of antennas and the CSI is generated for the mode.

In some implementations, the first precoding information may indicate a number of a first group of antennas of the UE, and the second precoding information may indicate a number of a second group of antennas of the UE.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method for an apparatus communicating with a network node, comprising:
generating, by a processor of the apparatus, first precoding information implying a first precoding matrix and second precoding information implying a second precoding matrix according to a first channel response between the network node and a first group of antennas of the apparatus, a second channel response between the network node and a second group of antennas of the apparatus, and an assumption that a first signal precoded by the first precoding matrix and a second signal precoded by the second precoding matrix are transmitted from the network node on the same time-frequency resources, wherein the first signal is decoded based on first radio frequency (RF) signals received by the first group of antennas, and the second signal is decoded based on second RF signals received by the second group of antennas;
generating, by the processor, channel state information (CSI) including the first precoding information and the second precoding information; and
transmitting, by the processor, the CSI to the network node.

2. The method of claim 1, wherein the CSI further includes at least one of a first rank indicator (RI) equal to a number of columns of the first precoding matrix and first channel quality information (CQI) indicating channel quality for decoding the first signal, and at least one of a second RI equal to a number of columns of the second precoding matrix and second CQI indicating channel quality for decoding the second signal.

3. The method of claim 2, wherein transmitting of the CSI to the network node further comprises:
generating, by the processor, a first CSI report message including at least one of the first precoding information, the first RI and the first CQI, and a second CSI report message including at least one of the second precoding information, the second RI and the second CQI; and
transmitting, by the processor, the first CSI report message and the second CSI report message separately to the network node.

4. The method of claim 2, wherein transmitting of the CSI to the network node further comprises:
generating, by the processor, a CSI report message including the first precoding information, the second precoding information, at least one of the first RI and the first CQI, and at least one of the second RI and the second CQI; and
transmitting, by the processor, the CSI report message to the network node.

5. The method of claim 1, wherein the first group of antennas receives the first RF signals in a first frequency band, the second group of antennas receives the second RF signals in a second frequency band different from the first frequency band, and the first RF signals received in the first frequency band and the second RF signals received in the second frequency band carry the same baseband signals transmitted by the network node.

6. The method of claim 5, wherein the first group of antennas and the second group of antennas share at least one antenna.

7. The method of claim 1, wherein the first group of antennas and the second group of antennas receive the first RF signals and the second RF signals in the same frequency band, respectively, and the first RF signals and the second RF signals carry the same baseband signals transmitted by the network node.

8. The method of claim 1, further comprising:
receiving, by the processor, a data signal from the network node via the first group of antennas and the second group of antennas;
extracting, by the processor, a part of data from the data signal received by the first group of antennas; and
extracting, by the processor, a remaining part of the data from the data signal received by the second group of antennas.

9. The method of claim 1, further comprising:
receiving, by the processor via the first group of antennas and the second group of antennas, a plurality of reference signals transmitted by the network node; and
estimating, by the processor, the first channel response between the network node and the first group of antennas and the second channel response between the network node and the second group of antennas according to the referenced signals.

10. The method of claim 1, further comprising:
receiving, by the processor, a mode switching message from the network node; and
switching, by the processor, to a mode in which the first signal is decoded independently according to the first RF signals received by the first group of antennas and the second signal is decoded independently according to the second RF signals received by the second group of antennas according to the mode switching message.

11. The method of claim 1, wherein the first precoding information indicates a number of the first group of antennas, and the second precoding information indicates a number of the second group of antennas.

12. A method, comprising:
receiving, by a processor of an apparatus, CSI from a UE, wherein the CSI includes a first precoding information and a second precoding information;
generating, by the processor, a first precoded data signal and a second precoded data signal according to the CSI; and
transmitting, by the processor, the first precoded data signal and the second precoded data signal to the UE on the same time-frequency resources.

13. The method of claim 12, wherein the CSI further includes at least one of a first RI and a first CQI, and at least one of a second RI and a second CQI.

14. The method of claim 13, wherein receiving of the CSI from the UE further comprises:
receiving, by the processor, a first CSI report message including at least one of the first precoding information, the first RI and the first CQI; and
receiving, by the processor, a second CSI report message including at least one of the second precoding information, the second RI and the second CQI.

15. The method of claim 13, wherein receiving of the CSI, from the UE further comprises:
receiving, by the processor, a CSI report message including the first precoding information, the second precoding information, at least one of the first RI and the first CQI, and at least one of the second RI and the second CQI.

16. The method of claim 13, wherein the first RI, the first CQI and the first precoding information correspond to a first group of antennas of the UE, and the second RI, the second CQI and the second precoding information correspond to a second group of antennas of the UE.

17. The method of claim 12, further comprising:
transmitting, by the processor, a plurality of reference signals to the UE for generating the CSI based on measurement of the reference signals.

18. The method of claim 12, further comprising:
transmitting, by the processor, a mode switching message to the UE, wherein the mode switching message indicates the UE to switch to a mode in which the first precoded data signal is decoded independently according to first RF signals received by the first group of antennas, the second precoded data signal is decoded independently according to second RF signals received by the second group of antennas and the CSI is generated for the mode.

19. The method of claim 12, wherein the first precoding information indicates a number of a first group of antennas of the UE, and the second precoding information indicates a number of a second group of antennas of the UE.

20. An apparatus, comprising:
a transceiver which, during operation, wirelessly communicates with a network node; and
a processor communicatively coupled to the transceiver such that, during operation, the processor performs operations comprising:
generating first precoding information implying a first precoding matrix and second precoding information implying a second precoding matrix according to a first channel response between the network node and a first group of antennas of the apparatus, a second channel response between the network node and a second group of antennas of the apparatus, and an assumption that a first signal precoded by the first precoding matrix and a second signal precoded by the second precoding matrix are transmitted from the network node on the same time-frequency resources, wherein the first signal is decoded based on first RF signals received by the first group of antennas, and the second signal is decoded based on second RF signals received by the second group of antennas;
generating CSI including the first precoding information and the second precoding information; and
receiving, via the transceiver, the CSI to the network node.
